(19) United States
(12) Patent Application Publication
(10) Pub. No.: US 2006/0078123 A1
(43) Pub. Date: Apr. 13, 2006

(54) Method and apparatus for banding multiple access points

(76) Inventors: Guillaume Bichot, La Chapelle Chaussee (FR); Sachin Satish Mody, Lawrenceville, NJ (US)

Correspondence Address: THOMSON LICENSING INC., PATENT OPERATIONS, PO BOX 5312, PRINCETON, NJ, 08543-5312, US

(21) Appl. No.: 10/541,860

(22) PCT Filed: Jan. 9, 2004
(86) PCT No.: PCT/US04/00517

§ 371 Date: Jul. 11, 2005

Related U.S. Application Data
(60) Provisional application No. 60/439,087, filed on Jan. 9, 2003.

(51) Int. Cl. H04K 1/00

(52) U.S. Cl. 380/270

(57) ABSTRACT

The invention relates generally to a method and an apparatus for synchronizing a digital transmission using beacon packets, and in particular, by using beacon packets utilized in communication between a wireless access point and a wireless station in accordance with operating in accordance with the Institute of Electrical & Electronics Engineers' IEEE standard 802.11. A communication device comprises a means for creating a plurality of logical access points; a means for downloading a SSID into a mobile terminal in accordance with a user's of communication reception; and a means to permit the mobile terminal to switch from one logical access point to second logical access point depending on the current state of the logical access point and the user's choice.

This application claims the benefit of U.S. Provisional Application No. 60/439,087 filed Jan. 9, 2003.

### FIELD OF THE INVENTION

The invention provides an apparatus and a method to extend the capacity of a wireless local area network (“WLAN”) through the wireless access point to a wireless station network, by provisioning resources according to user requests or network policy in choosing either an Internet communication or a video broadcast operation. The invention is particularly suited for use in an environment implemented in accordance with the Institute of Electrical & Electronics Engineers' IEEE 802.11.

### DESCRIPTION OF RELATED ART

The context of the present invention is the family of wireless local area networks or WLAN specifications developed by the Institute of Electrical and Electronic Engineers (IEEE). The IEEE 802.11 standards define a WLAN's access point (e.g., local area network access point or LAP), which provides access for mobile devices to the WLAN and to other networks, such as hard wired local area networks and global networks, such as the Internet. Wireless receiving points utilized in conditional access broadcasting may include a set top box in a simple system, whereas in commercial rebroadcast systems a transcoder/multiplexer/demultiplexer or TMD may operate in conjunction with a local video server. One such wireless access point may receive input from a set top box as is utilized in conditional access broadcasting.

FIG. 1 illustrates an exemplary digital video and audio system suitable for implementing the present invention. Input to a wireless access point 145 can be received from a gateway 180 connected to the Internet or from a broadcast system via a video LAN 121. In a conventional broadcast system, a head end 110 transmits multiple video and audio content streams as converted into a digital format (typically MPEG-2) via satellite to a receiving dish 106, or other suitable means, which is attached to a TMD 123. U.S. Pat. No. 6,510,519, describes a typical system utilizing a head end and a set top box including tuners, demodulators, decoders, transport de-multiplexers, microprocessors, program memories, video picture memories, MPEG video decoders, displays, and smart cards. Most digital broadcast system data streams are encoded or scrambled for security purposes and once decryption occurs, the system builds a video composite picture in memory, typically in accordance with the MPEG-2 standard, and displays the desired picture on a display. In addition to descrambling the program, generally, further authorizations are provided to insure that the particular set top box has been enabled to receive a program or a set of programs.

As further illustrated in FIG. 1, the TMD 123 may be designed and configured to further communicate with the wireless access point (AP) 145, which in the illustrative example provided, receives demultiplexed output including its timing signals so as to synchronize the transmission of the video and audio content.

The IEEE 802.11 standard defines a WLAN architecture that is built around the notion of a Basic Service Set or BSS which is regarded as a basic building block. The BSS consists of a group of any number of access point stations that communicate with one another. In each independent BSS, the mobile stations communicate directly with each other. In an infrastructure BSS, all stations in the BSS communicate with the access point and no longer communicate directly with the independent BSS such that all frames are relayed between stations by the access point. The proposed invention is particularly suitable for implementation in the context of an Infrastructure BSS.

In order to effectively communicate in a network through a wireless connection to a wireless access point the various devices in the WLAN must be synchronized so as to particularly avoid pauses or jumps in the video presented to the display. The video content is typically stored in a forward and store buffer, where it awaits the clock signals that move it into the video subsystems for display. If the digital video source leads, or transmits digital video signal before the destination has emptied its buffer and presented the video, the destination's forward and store buffer will overflow, causing a loss of video data. Conversely if the digital video destination store and forward buffer empties or leads the digital video source, the destination's buffer can underflow leading to pauses, or freezes, in the video presentation. By synchronizing the rate at which the data is transmitted, stored, and consumed with respect to the rate at which it is produced, reduces or eliminates these undesirable consequences.

Currently constituted Broadband Internet access via WLAN has limited radio resources, which in turn limits the number of users that each access point can service. For example, in a public access a WLAN based on IEEE 802.11b, an AP provides an overall bandwidth in the range of seven megabits per second (7 Mbit/s). Depending on the application, the medium can be quickly overloaded. A video application requiring 500 kbit/s allows a maximum of 12 users.

One way to deal with these limitations would be to enhance the coverage of any geographical location by banding together multiple APs. Such a banding technique would require a mobile terminal and an associated network to negotiate the AP with which the mobile terminal should associate with in accordance with user preference and network policy.

As WLAN technology evolves under the IEEE 802.11 standards, limitations are becoming more clearly evident. New technologies such as ETSI Hiperlan2 and IEEE 802.11a bring advantages that will become necessary for all network operators in the future. One-way to solve these problems is to combine two or more APs together, each operating in its own frequency band/protocol.

If multiple APs' are in operation, the mobile terminal must then determine which AP, out of the available ones within range, with which it should associate. Typically, the mobile terminal selects the AP that belongs to a particular SSID (Service Set Identifier) and in case of several APs, the one that has the strongest signal strength, and in case of several contenders, simply the first AP. These may not be the optimal methods for selecting an AP and does not account for user preferences. What is required is a means that permits a mobile terminal to associate with the AP on the basis of network policy decisions and the users preferences.

### SUMMARY OF THE INVENTION

The invention provides an apparatus and a method to combine several WLAN radio technologies and to extend the capacity of a WLAN network through the wireless access point to a wireless station, by provisioning resources on the basis of a user to choosing either an Internet communication or a video broadcast. The invention then determines a corresponding SSID associated with one or more logical access points according to user requests or network policy.

The invention provides for a communication system comprising: a means for creating a plurality of logical access points; a means for downloading a SSID into a mobile terminal in accordance with a user's communication reception, means to permit the mobile terminal to switch from one logical access point to second logical access point depending on the current state of the logical access point and the user's choice. The receiver further comprises a means to authenticate and to receive an application proposal in accordance with one or more services on the Internet or video broadcast system. In one embodiment the mobile terminal disconnects from the logical access point currently connected and associates with the logical access point that corresponds to the SSID associated with the newly selected service.

The invention also provides for a method of allowing a user to choose either an Internet communication or a video broadcast and a corresponding SSID associated with one or more logical access points according to user requests or network policy by creating a plurality of logical access points; downloading a SSID into a mobile terminal in accordance with a user's communication reception; switching the mobile terminal from one logical access point to second logical access point depending on the current state of the logical access point and the user's choice; and authenticating and receiving an application proposal in accordance with one or more services on the Internet or video broadcast system.

In one embodiment, the method includes choosing a video broadcast and a SSID corresponding to one of the logical access points and disconnecting from the logical access point currently connected and associating with the logical access point that corresponds to the SSID by the gateway as well as alternatively terminating a video broadcast service by disconnecting the mobile terminal and re-connecting the mobile terminal with a second logical access point using the well known SSID.

### BRIEF DESCRIPTION OF THE DRAWINGS

The invention is described with the following detailed description with the accompanying drawings.

FIG. 1 is a block diagram of a conditional access system.

FIG. 2 is a block diagram of a multi frequency AP network.

FIG. 3 is a block diagram of a local broadcasting service of the present invention.

FIG. 4 is a block diagram of a method of the present invention.

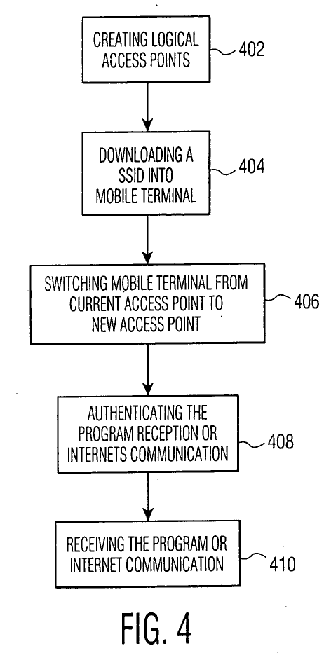

### DETAILED DESCRIPTION OF THE INVENTION

In the figures to be discussed the circuits and associated blocks and arrows represent functions of the process according to the present invention which may be implemented as electrical circuits, and associated wires or data busses, which transport electrical signals, and/or software modules. Alternatively, one or more associated arrows may represent communication (e.g., data flow) between software routines, particularly when the present method or apparatus of the present invention is implemented as a digital process.

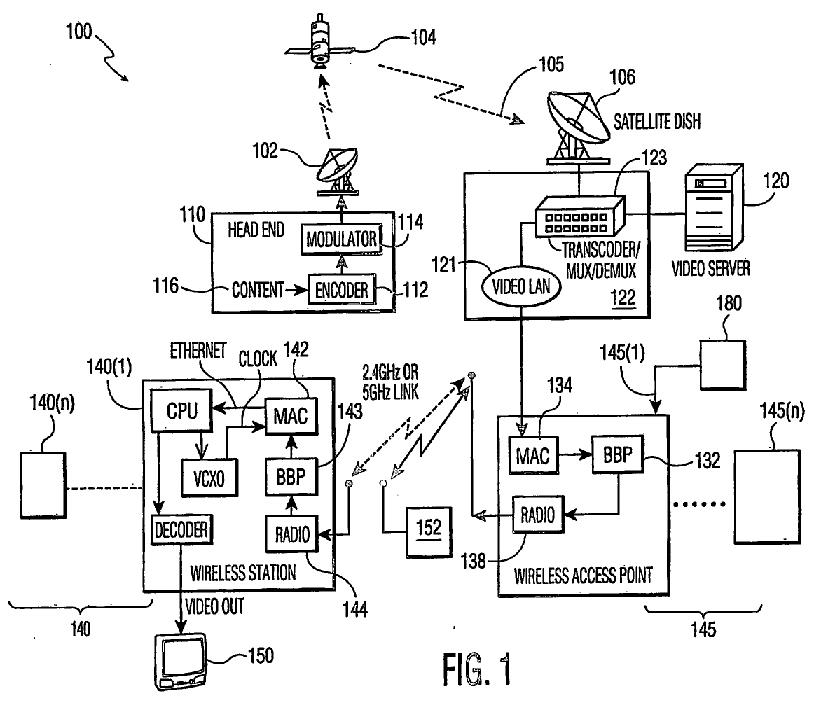

The prior art shown in FIG. 1 provides an overview of a service provider 100 system that supplies AIV programming, for example, television programming in accordance with a digital television standard. All digital broadcast system data streams contain video, audio, timing information and are encoded or scrambled for security purposes, that is to insure only authorized subscribers can view the programs transmitted.

In a subscriber based digital broadcast system, the customer receives, in addition to the video and audio information, various administrative and control messages such as entitlement control messages, which contain an exploitation key necessary to decrypt the encrypted control word necessary to decode a descrambling key so as to permit the decryption and assembling of the digital video and audio data. Once decryption occurs, the system builds a video composite picture in memory, typically in accordance with the MPEG-2 standard, and displays the desired picture on a display.

In accordance with FIG. 1, a head end 110 digitally formats video and audio content 116, in an encoder 112, which are modulated by modulator 114 so as to be transmitted from a transmitter 102 via satellite 104 to a receiving dish 106 located at a receiving end for television service to conditional access customers.

The receiving end typically is a TMD 123 operating in conjunction with a local video server 120, which electronically connects to the receiving dish 106. The TMD 123 contains a demodulator (not shown) that demodulates the composite video and audio data signal and various administrative and control messages and outputs the demodulated signal to a central processing unit (not shown) that processes the many packetized streams by routing select packets to various control, data and status subsystems. For example, typically the selected packetized video and audio stream is sent to a decoder (not shown) for translation into a format suitable for an ultimate output to a mobile terminal, also referred to more generally as a wireless station 140, which serves as the receiving device for devices such as a television 150 operating in accordance with NTSC, PAL or SECAM formats, or laptop computer, cell phone or PDA all designated by reference 152 and operating in accordance with IEEE 802.11 standards.

A wireless compliant device may be representative of wireless station 140, which may, in turn, depict a laptop personal computer, a handheld device, or may be representative of an access point 145 which manages other wireless stations, such as wireless station 140. Therefore, stations 140 may be mobile, portable, or stationary and all stations that are IEEE 802.11 compliant provide services of authentication, de-authentication, privacy, and data delivery.

The IEEE 802.11 standards incorporate a synchronization feature known as a beacon packet which is regularly broadcasted. This packet synchronizes the APs 145 with the station it manages. The wireless station 140 CPU uses this beacon information to control its MAC 142 system to, among other things, adjust the rate the wireless station 140 consumes data as well as to provide a management frame, which may contain extra information about the loading of the APs 145.

The present invention is directed to a communication system that may include a conditional access broadcast 100 system utilizing an MPEG-2 video and audio data stream or an Internet gateway operating under typical internet protocols such as IP/TCP and associated IP-based RTP/UDP/IP stacks capable of MPEG-2 to present data, to an IEEE 802.11 compliant architecture, that is a wireless local area access device as indicated by transmission 160 utilizing one or more wireless access points 145 (l) through 145(n) and one or more wireless stations 140 (l) through 140 (n). An IEEE 802.11 compliant system is comprised of several components, each of which contains a Medium Access Control or MAC 134, 142, Base Band Process or BBP 132, 143, and radio receiver/transmitters 138, 144 as well as services that interact to provide station mobility transparent to the higher layers of the network stack. However, a station is any device that contains the functionality of the IEEE 802.11 protocols, that being MAC and Physical Layer or PHY, and a connection to the wireless media, such as one or more wireless stations 140. Typically, the IEEE 802.11 protocols are implemented in the hardware and/or software of a network interface card (not shown). By way of example, the wireless station 145 (l) connects to other wireless medium such as wireless station 140 (l) through a radio communication medium.

A wireless compliant device may be representative of wireless station 140, which may in turn, depict the communications component of a laptop personal computer, a handheld device, or may be representative of other access points such as 145 (l), which manages wireless stations 140, such as wireless station 140(l). Therefore, stations may be mobile, portable, or stationary and all stations that are IEEE 802.11 compliant provide for services of authentication, de-authentication, privacy, and data delivery.

The SSID (Service Set Identifier) is a maximum 32 byte string that identifies the network operator. The APs 145 broadcast the SSID in each beacon frame. A mobile terminal that desires to associate with one of the APs 145 that belong to the SSID scans frequencies until it can detect a beacon frame with the SSID that matches the one it has configured.

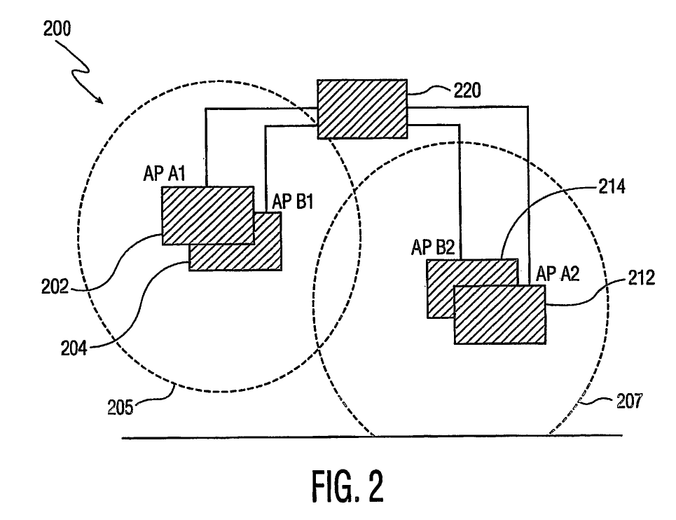

An embodiment of the invention provides for a communication device, which may be incorporated into a communication system such as the TMD 123 or the wireless access point 145 (l), which includes, logically programmed in either software or hardware: means, for creating a plurality of logical access points; a means for downloading a SSID into a mobile terminal in accordance with a user's of communication reception, means to permit the mobile terminal to switch from one logical access point to second logical access point depending on the current state of the logical access point and the user's choice. The TMD 123 further include logically programmed in either software or hardware: means to authenticate and to receive an application proposal in accordance with one or more services on the Internet or video broadcast system. In one embodiment, shown in FIG. 2, one of the wireless stations 140 disconnects from the logical AP 202 with which it is currently connected and associates with the logical AP 204 that corresponds to the SSID associated with the newly selected service.

In referring to FIG. 2, a logical AP 205 has exactly the same role and the same function represented by wireless station 140. Each logical AP pair AP A1 202 and AP A2 212 share an SSID, referred to by way of explanation as SSID A (not shown). Each logical AP pair, AP B1 204 and AP B2 214 share an SSID referred to by way of explanation as SSID B (not shown). The mobile terminal associates such as wireless station 140 with the AP 145 (l) through 145 (n) that at the time wireless station 140 initiates communication is less loaded or has less communications traffic.

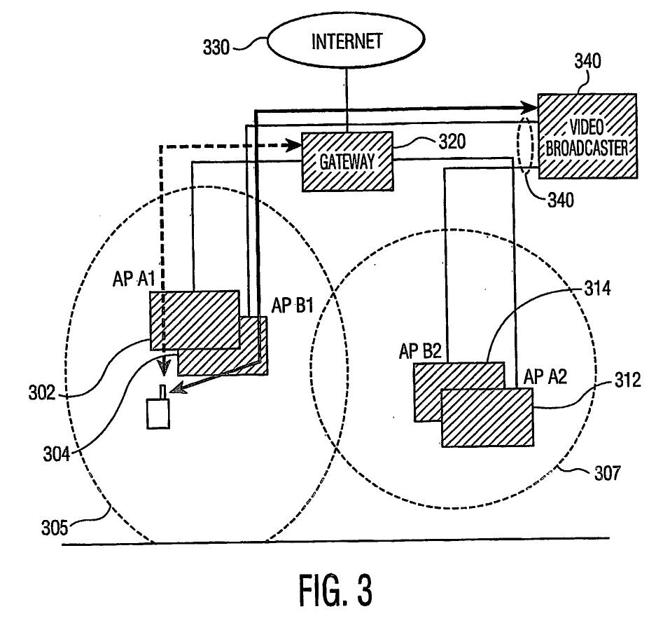

In another embodiment of the present invention, shown in FIG. 3, each logical pair AP A1 302 and AP A2 312 is associated with a predefined function. For example, the logical pair AP A may be dedicated for Internet access whereas the logical pair AP B may be dedicated to local video broadcasting. The present invention allows the wireless station 140 to be associated with the AP, as function of the user request or as a function of the network policy.

For both cases mentioned above, the solution to choosing the SSID is based on the assumption that an SSID is required in the WLAN. Actually the wireless station 140 may be connected without knowledge of the SSID. However, this may create problems, especially in high-density population areas, where there might be several different APs within a given coverage area.

In one embodiment of the present invention each wireless station 140 is configured with a master SSID, corresponding to the multi-frequency AP network. Each logical AP in a multi-frequency AP has a different SSID. One of the logical APs owns the master SSID. In accordance with an embodiment of the present invention the APs A (A1 and A2 in FIG. 2) share the master SSID and APs B (B1 and B2 in FIG. 2) share a different SSID not known in advance by one of the wireless stations 140.

When a wireless station such as wire station 140(l) enters the coverage area of the multi-frequency AP such as AP A1 302, it scans the frequencies and tunes to the one that corresponds to the well-known SSID. The terminal authenticates and associates with the AP A1 302.

The beacon management frame, which is regularly broadcast, may contain extra information about the loading of the AP, as in the prior art, or as in an embodiment of the present invention, which contains the particular functionality of the AP and an alternative SSID (corresponding to the second logical AP) as well as other information such as the radio technology and the loading ratio or the network functionality of the AP.

Alternatively, after being authenticated by the local network provider, an application level exchange takes place between the wireless station 140(l) and the network. This application offers the choice of different functionalities as Internet access, video broadcasting etc. According to the user choice, the corresponding SSID is downloaded into the terminal. The terminal can then switch, if it is necessary to the new AP.

FIG. 3 illustrates the embodiment where the corresponding SSID is downloaded into the wire station 140(l) in accordance with the user choice, wherein the wire station 140(l) is switched from one logical AP to another depending on its current state. The wireless station 140(l) initially associates with logical AP A1 302. The user then authenticates via a gateway 320 and the application proposes different services regarding the Internet 330 access or video broadcast 340. If the user chooses video broadcast 330, a SSID corresponding to the “B” network 340 (corresponding to AP B1 304 and AP B2 314) is delivered to the mobile application with corresponding descrambling information. For example, the wireless station 140(l) connected to logical AP A1 302 disconnects from the logical AP A1 302 and associates with AP B1 304 that corresponds to the SSID previously allocated by the gateway 320. Whenever the user desires to terminate the video broadcast 340 service, the wireless station 140(l) disconnects from AP B1 304 and re-connects with the logical AP A1 302 using the well known SSID. The two logical APs A and B typically operate on different frequency channels.

In a Hiperlan2 compliant implementation, the NOP ID is equivalent to the SSID in IEEE 802.11. The NOP-ID is also a 32 byte field but composed in two parts. One global part is allocated by the ETSI organization whereas the other part called local part is allocated by the operator. The process described in the previous section applies to the ETSI Hiperlan2 standard as well.

The invention also provides for a method of allowing a user to choose either an Internet communication or a video broadcast and a corresponding SSID associated with one or more logical access points according to user requests or network policy by creating a plurality of logical APs 402; downloading a SSID into a wireless station 404, in accordance with a user's communication reception; switching the wireless station from one logical APs to second logical AP 406 depending on the current state of the logical AP and the user's choice; authenticating 408 and receiving an application 410 in accordance with one or more services on the Internet 330 or video broadcast system 340.

In one embodiment of the invention, the method includes choosing a video broadcast 340 and a SSID corresponding to one of the logical APs and disconnecting from the logical AP currently connected and associates with the logical AP that corresponds to the SSID by the gateway 320 as well as alternatively terminating a video broadcast 340 service by disconnecting the wireless station 140(l) and re-connecting the wireless station 140(l) with a second logical AP using the well known SSID.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims. For example, although the invention is described in the context of IEEE 802.11 or Hiperlan2 based WLANs, it is to be understood that the invention may be applied to structures based on other wireless LAN standards wherein the synchronization is to be maintained.

1-13. (canceled)

14. A communication system comprising:
a means for creating a plurality of logical access points; and
a means for transmitting identifiers associated with selected ones of the logical access points into a mobile terminal in accordance with a communication reception; and
a means to permit the mobile terminal to select a first logical access point or a second logical access point in response to a service requested by the mobile terminal and a service set provided by the first or second logical access point.

15. The communication system in claim 14, further comprising:
a means to authenticate; and
a means to receive an application proposal in accordance with one or more communication services.

16. The communication system in claim 15, wherein the identifier comprises service set identifier in IEEE 802.11 compliant access points, and further comprising:
a means for the user to choose a service and a service set identifier corresponding to one of the logical access points; and
a means to disconnect from the logical access point and associate with the logical access point that corresponds to the service set identifier designated by the gateway.

17. The communication device in claim 16, further comprising:
a means to terminate a service by disconnecting the mobile terminal and re-connecting the mobile terminal with a second logical access point using a well known service set identifier.

18. The communication device in claim 14, further comprising:
one or more logical access points operating on different frequencies.

19. The method according to claim 17, further comprising:
creating a plurality of logical access points; and
switching said device from said first logical access point to said second logical access point further based on a current state of said second logical access point.

20. The method in claim 19, further comprising the steps of:
authenticating; and
receiving an application proposal in accordance with one or more communication services.

21. The method claim 20, further comprising the steps of:
choosing a service and a service set identifier corresponding to one of the plurality of logical access points; and
disconnecting from the one logical access point of said plurality of logical access points not selected and associating with the logical access point of said plurality of access points that corresponds to the service set identifier designated by a gateway.

22. The method in claim 21, further comprising the steps of
terminating a service by disconnecting the device; and
re-connecting the mobile terminal with the second logical access point using a well known service set identifier.

23. The method in claim 14, further comprising the step of:
operating one or more logical access points on different frequencies.

24. A method for controlling a mobile terminal device to obtain a desired service in a wireless local area network comprising a plurality of logical access points, comprising the steps of:
establishing communications with a first access point one of said logical access points to gain access to the wireless local area network;
downloading a plurality of identifiers associated with selected access points of the plurality of logical access points of the wireless local area network;
determining respective service sets provided by the selected access points;
comparing the respective service sets with a desired service to determine a suitable access point and its associated identifier;
associating with the suitable access point using the associated identifier; and
downloading the desired service from the associated suitable access point.

25. The method according to claim 24, wherein the mobile terminal device and the plurality of access points are IEEE 802.11 compliant devices and the identifiers comprise service set identifiers.

26. The method according to claim 24, wherein the mobile terminal device and the plurality of access points are Hiperlan2 compliant devices and the identifiers comprise NOP identifiers.

27. A device in a communication system comprising:
means for receiving by said device, identifiers associated with selected ones of a plurality of access points to a wireless station network; and
means to permit said device to select one of a first logical access point of said plurality of said logical access points and a second logical access point of said plurality of logical access points in response to a service requested by said device and a service set provided by one of said first logical access point and said second logical access point.

28. The device according to claim 27, wherein said device is a mobile terminal.

29. The device according to claim 27, wherein said device is a wireless station.

30. A method to extend the capacity of a wireless local area network through a wireless access point, said method comprising:
downloading a service set identifier to a device; and
switching said device from a first logical access point to a second logical access point based on a current state of said first logical access point and a choice of service requested by a user.

31. The method according to claim 30, wherein said device is a mobile terminal.

32. The method according to claim 30, wherein said device is a wireless station.
